(19) United States
(12) Patent Application Publication
(10) Pub. No.: US 2008/0306512 A1
(43) Pub. Date: Dec. 11, 2008

(54) Portable slant board anterior adjusting table

(76) Inventor: Frank Wallace Jeffries, IV, Marquette, MI (US)

Correspondence Address: Frank Wallace Jeffries IV, P.O. Box 222, Marquette, MI, 49855, US

(21) Appl. No.: 11/810,146

(22) Filed: Jun. 5, 2007

(51) Int. Cl. A61H 1/00

(52) U.S. Cl. 606/242

(57) ABSTRACT

This is a chiropractic adjusting table which makes correction of spinal misalignments in 1^{st} thoracic through 5^{th} lumbar easier on the doctor and patient and also does a better job than existing manual adjustment tables. It is new and revolutionary to the delivery of the chiropractic and/or osteopathic adjustment procedure. The uniqueness of the slant provides a mechanical advantage to quickly and easily correct misaligned vertebra. It provides a unique leverage advantage to gently adjust bones back into their proper position.

### CROSS-REFERENCE TO RELATED APPLICATIONS

(not applicable)

### STATEMENT REGARDING FEDERALLY SPONSORED RESEARCH OR DEVELOPMENT

(not applicable)

### REFERENCE TO SEQUENCE LISTING, A TABLE, OR A COMPUTER PROGRAM LISTING COMPACT DISC APPENDIX

(not applicable)

### BACKGROUND OF THE INVENTION

This invention pertains to use in health care settings where practitioners are licensed to administer spinal adjustments. In the United States at this time this would include Doctors of Osteopathic Medicine and Doctors of Chiropractic Medicine.

Over the years there have been several classic chiropractic tables invented which serve the doctors as a useful tool in rendering an efficient adjustment of the spine. I would reference you to a book written by Roger W. Herbert, D.C., entitled Gonstead Chiropractic Science and Art. It discusses the use of tables used for making spinal corrections. (p. 200 and p. 206). Dr. Gonstead had used the “Pelvic Bench” table and the “Knee-Chest” adjusting tables. With Gonstead's two tables spinal adjustments are rendered for the same purpose as the Portable Slant Board Anterior Adjusting Table. The PSBAAT mechanism is different. Gonstead's tables emphasized pushing the vertebra posterior to anterior with the doctor's chest and head being posterior to the patient. The Portable Slant Board Anterior Adjusting Table is also good for adjusting thoracic vertebra #1 through lumbar vertebra #5 but allows the doctor to stay anterior to the patient's body using the patient's own body weight as leverage. This repositions a fixed vertebra with much less work for the doctor and is easier on the patient. The goal of the PSBAAT is to provide a better tool to correct misaligned vertebra (T1-L5) in a more efficient and effective manner.

There are also in existence anterior adjusting boards. These are simply flat padded boards placed flat on a bench or a flat padded board mounted vertically on a wall. Making anterior spinal corrections on a flat surface or against the wall is difficult, hard on the doctor and hard on the patient. The PSBAAT is also much more effective because of its angle in leveraging the fixed vertebra back into place. The specified angle or slant is at the essence of its uniqueness.

The general idea of the proposed invention is this: Doing a classic posterior chiropractic adjustment for segments T1-L5 vertebra is difficult physically on the doctor of chiropractic and awkward for the patient. Using the already existing anterior adjusting flat boards placed flat on a surface or vertically mounted on the wall is hard physically on the doctor and uncomfortable for the patient. The PSBAAT makes better both of these problems and, in fact, renders a superior chiropractic or osteopathic correction. This new table enables one to set the bones easily (for doctor and patient) and more thoroughly back where they should be. The object of the slant board table is to make the spinal correction of the first thoracic and fifth lumbar easier on the doctor, easier on the patient and to limit wear and tear on the doctor's body. This table makes the process of correction less painful for the patient and more easily puts the vertebra backs in its proper position.

### BRIEF DESCRIPTION OF THE SEVERAL VIEWS OF THE DRAWINGS

FIG. 1 A: This is the classic above-angled view of the PSBAAT, One can see the slant board with the dimensions here showing the classic 34 degree angle. Other angles can be created based on the individual needs of the patient as determined by the doctor. One can see; 1.) The slant board 2.) The foam pad and leather cover 3.) The wedge piece 4.) The hinged mechanism 5.) The base flatboard and 6.) The roughened undersurface (to keep the table from slipping). Note dimensions on drawing for construction. FIG. 1 B. This is the wedge piece drawing and pertinent dimensions for construction. FIG. 1 C. Hinge mechanism drawing, dimensions of the hinge, and components for attachment.

### DETAILED DESCRIPTION OF THE INVENTION

This invention is simply a solid wood board (22″×22″×¾″) that is hinged (22′×1½″ hinge) to a flat board of the same size with a separate wedge piece to be used to create the proper angle for the adjustment as determined by the doctor. The classic angle I prefer is 34 degrees but other doctors may prefer a different slant, which, of course, would create a different angle. The dimensions of the wedge piece will change based on the slant (and resulting angle) requested by the doctor. There has never been another portable slant board anterior adjusting table; this is the first of its kind.

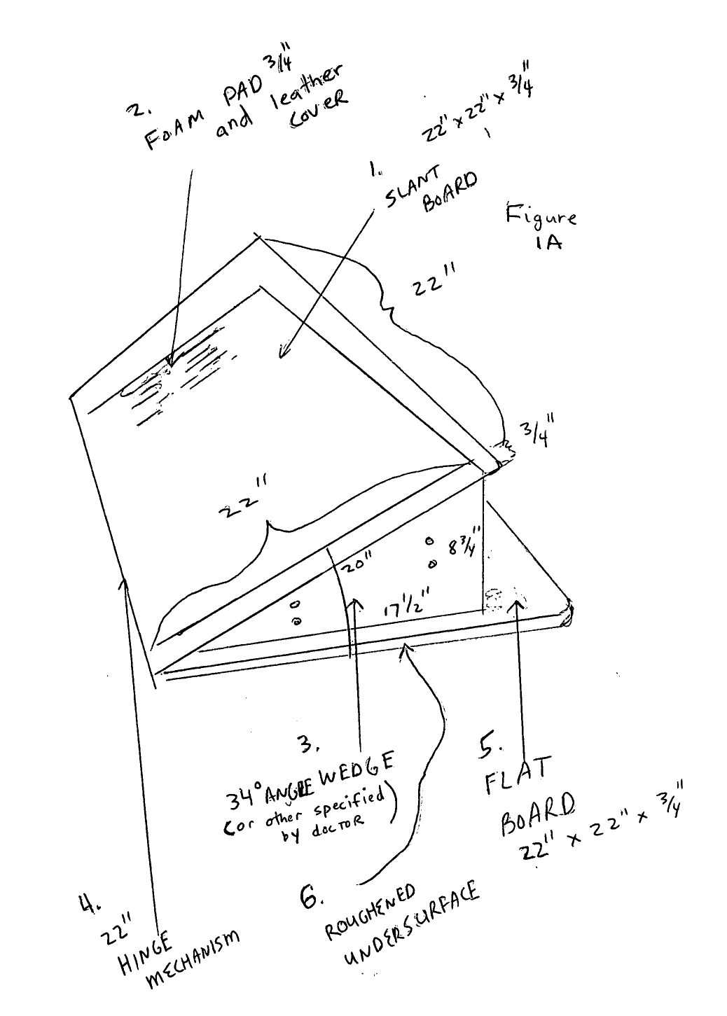

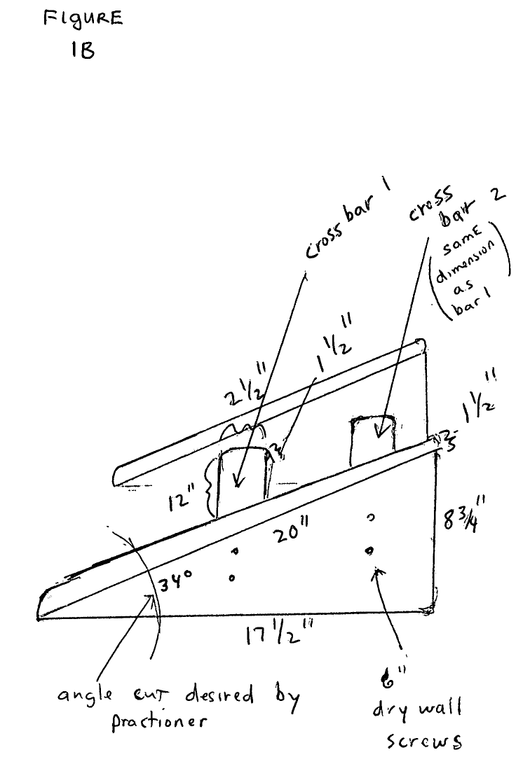

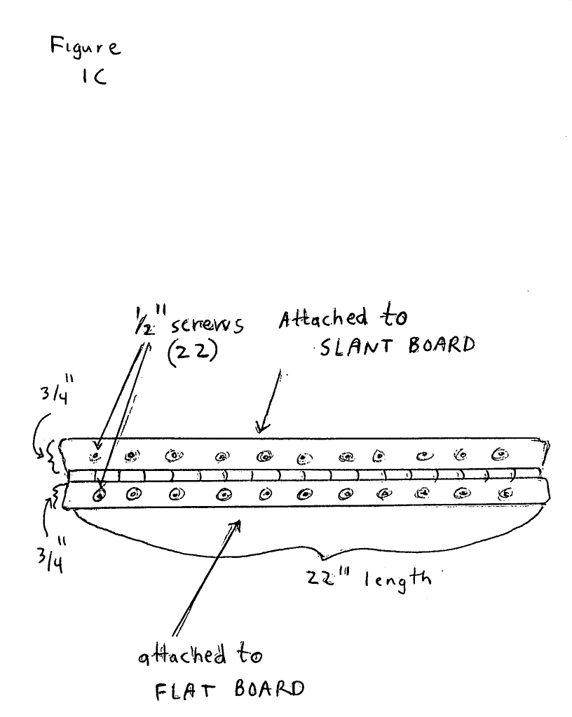

The slant board (FIG. 1 A) is a 22″×22″×¾″ piece of solid wood; the padded cover is ¾″ thick covering the entire top surface of the slant board. The slant board itself is attached to the flat board (22″×22″×¾″) by a 22″ long piano hinge. The wedge piece (FIG. 1 B) is simply two angled pieces cut at a specified angle out of wood. If one chooses the classic 34 degree angle then the two wedge pieces should be 20″×17½″×8¾″×1½″. They are connected by two crossbars. The dimensions of the crossbars are 12″×2½″×½″. Eight 6 inch screws are required to tie the two wedges together. The wedge piece is a completely independent and removable component of the PSBAAT and can be taken for out to ensure better portability of the PSBAAT unit. The flat board portion of the table (FIG. 1A) has a non-skid rubber mat attached to prevent motion during use. All exposed wooden edges are beveled at a 45 degree angle and all exposed wood is varnished.

1. My claim is that the PSBAAT provides a revolutionary new device for helping correct spinal misalignments (in Chiropractic and Osteopathic Clinics) for regions 1^{st} thoracic vertebra through 5^{th} lumbar vertebra.
